(19) United States
(12) Patent Application Publication
(10) Pub. No.: US 2020/0005345 A1
(43) Pub. Date: Jan. 2, 2020

(54) WEB BASED SYSTEM AND METHOD PROVIDING A MARKETPLACE FOR CREATIVE DIGITAL CONTENT DISCOVERY AND DISTRIBUTION FOR ARTISTS

(71) Applicant: Karl A. Talla Demgueu, Bristow, VA (US)

(72) Inventor: Karl A. Talla Demgueu, Bristow, VA (US)

(21) Appl. No.: 16/020,034

(22) Filed: Jun. 27, 2018

(51) Int. Cl. G06Q 30/02; G06Q 30/06; H04M 1/725

(52) U.S. Cl. CPC G06Q 30/0208; H04M 1/72558; G06Q 30/0625

(57) ABSTRACT

A Web based system and method providing a marketplace for creative digital content discovery and distribution for an artist. The invention provides a creative content discovery marketplace where an artist can provide an incentive for a listener to experience their creative content. The artist uploads their creative content to a creative content storage and specifies an incentive and one or more parameters for allocating the incentive to a listener. The listener is able to discover content based on the incentive and experience the content.

### BACKGROUND OF THE INVENTION

The present invention relates to creative digital content distribution and promotion, more particularly, to music distribution and promotion via the Internet.

For aspiring artists, such as musicians, it may be difficult to penetrate current marketplaces due to artificial industry imposed barriers. For new and emerging musicians, these barriers limit opportunities for getting their creative works discovered by fans, listeners, or otherwise generate an audience to listen to and enjoy their creative works.

While there are different Internet based alternatives that allow for musicians to distribute their content, a number are simply distribution outlets for musicians that have already gained popularity. Usually, these are fee based services that provide the artists, and the industry an alternative revenue stream.

Other, content websites and apps that allow for new artists to post their content don't guarantee that their created music will be heard by anyone. With the vast number of other artists' works on these sites, limitations remain for the discovery process for any new artist. Existing sites, simply don't work well for artists without an audience there is no way to guarantee that it will be heard. Ultimately, a goal for most musicians is to have others listen to their creative works.

As can be seen, there is a need for an improved content distribution marketplace that provides creative artists an opportunity for their works to be discovered.

### SUMMARY OF THE INVENTION

In one aspect of the present invention, a method of serving web pages providing a marketplace for discovering creative content of an artist is disclosed. The method includes the steps of: receiving an upload of a creative content via a content submission page hosted by a server of a creative content discovery service provider; receiving one or more artist specified identifying indicia for the creative content via the content submission page; storing the creative content on a content data store; receiving an incentive and one or more incentive parameters associated with the creative content via an incentive designation page hosted by server; storing the incentive in an incentive account associated with the artist and the creative content; and providing a creative content search page accessible at the server, wherein the creative content is searchable by the identifying indicia and the incentive associated with the creative content. In other steps, the server delivers a listener selected creative content from the content data store to the listener.

Other steps include: automatically receiving, at the server, a playback start time of the selected creative content from the listener: automatically receiving, at the server, a playback end time of the selected creative content from the listener and determining a playback duration. The method may also automatically determine whether the playback duration meets the one or more incentive parameters. When the one or more incentive parameters are satisfied, an incentive increment based on the playback duration and the one or more incentive parameters is automatically determined by the server, the incentive increment is delivered to a listener specified account; and the incentive increment is decremented from the incentive account.

In some embodiments, the server determines whether a subsequent incentive increment, based on a full play of the creative content is available in the incentive account, and automatically blocks access to the creative content when a subsequent incentive increment based on a full play of the creative content is not available.

Other aspects of the invention include a non-transitory computer-readable memory is adapted for use by a digital content discovery service provider in serving web pages offering a marketplace for discovering digital content of a creating artist, the non-transitory computer-readable memory is used to direct a server of the content discovery service provider to perform process steps. The steps include: receiving an upload of a creative content via a content submission page hosted by a server of a creative content discovery service provider; receiving one or more artist specified identifying indicia for the creative content via the content submission page; storing the creative content on a content data store receiving an incentive and one or more incentive parameters associated with the creative content via an incentive designation page hosted by server; storing the incentive in an incentive account associated with the artist and the creative content; and providing a creative content search page accessible at the server, wherein the creative content is searchable by the identifying indicia and the incentive associated with the creative content.

Other embodiments include the step of delivering a listener selected creative content from the content data store to the listener. A playback start time of the selected creative content from the listener may be automatically received at the server. In yet other embodiments, a playback end time of the selected creative content is from the listener and is used to determine a playback duration. The steps may then include automatically determining, at the server, whether the playback duration meets the one or more incentive parameters. If the one or more incentive parameters are satisfied, an incentive increment based on the playback duration and the one or more incentive parameters is determined the incentive increment and automatically delivering to a listener specified account; and the incentive increment is automatically decremented from the incentive account.

In yet other embodiments, the process steps include: determining whether a subsequent incentive increment based on a full play of the creative content is available in the incentive account; and automatically blocking access to the creative content when a subsequent incentive increment based on a full play of the creative content is not available in the incentive account.

In yet other aspects of the invention, a non-transitory computer-readable memory is adapted for use by a mobile computing device to access a site a digital content discovery service provider serving web pages offering a marketplace for discovering digital content of a creating artist. The non-transitory computer-readable memory is used to direct the mobile computing device to perform the steps of access a listener account hosted by the server; receiving a creative content from a creative content data store of the service provider; automatically sending a playback start time to the server upon initiating a playback of the creative content; and automatically sending a playback stop time to the server upon terminating a playback of the creative content, wherein the playback start time and the playback stop time are used to determine a playback duration, and the playback duration is used to determine an incentive increment for the playback of the creative content. In other embodiments, the process steps may also include providing a search interface, to search for the creative content based on an incentive specified by an artist associated with creative content.

These and other features, aspects and advantages of the present invention will become better understood with reference to the following drawings, description and claims.

### BRIEF DESCRIPTION OF THE DRAWINGS

FIG. 1 is a schematic view of a marketplace for creative digital content discovery and distribution for artists.

FIG. 2 is a flow chart of for an artist participation in the creative content discovery marketplace.

FIG. 3 is a flow chart of a listener participation in the content discovery marketplace.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved Internet based creative content discovery marketplace for aspiring artists, such as musicians, to have their creative works discovered by others. As stated above, despite the increased accessibility of Internet based creative content distribution outlets, new and emerging musicians still face difficulties getting discovered by fans, listeners, or audiences.

Currently, music sites such as soundcloud, simply allows an artist to post their creative music content in hopes that somebody first finds it, and second chooses to listen to it. Unlike conventional sites, the creative content discovery marketplace according to aspects of the present invention allows the artist to provide an incentive to encourage listeners to discover and listen to their creative content. Unlike a retail driven marketplace, where the listener is treated as a revenue source that pays for their consumption of creative content, the marketplace created by the current invention incentivizes listeners to discover creative content without the need to pay.

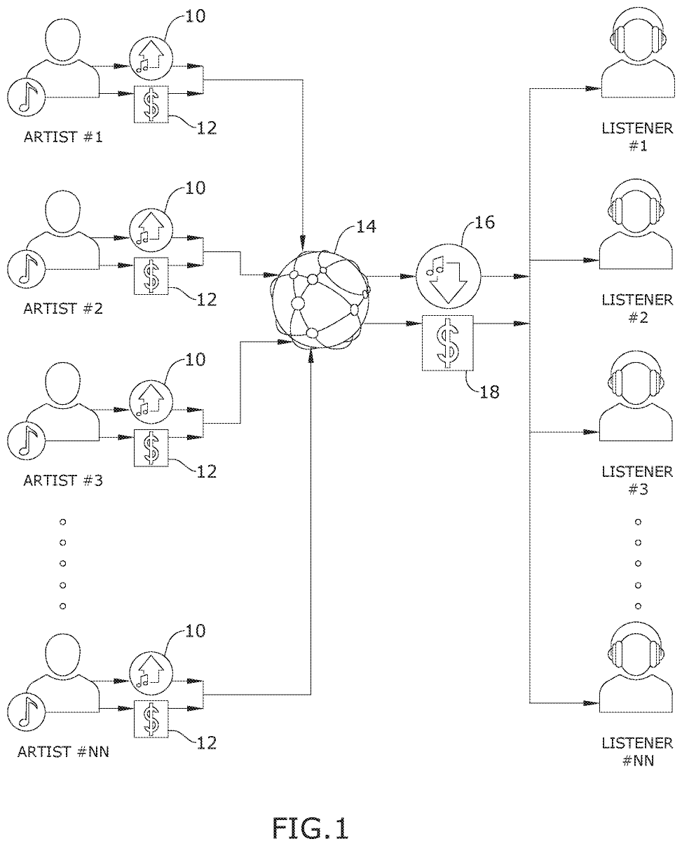

FIG. 1 illustrates a representative embodiment of a creative content and discovery marketplace for aspiring artists, in which one or more artists may utilize a computing device to provide uploaded creative content 10 to an Internet based creative content and discovery marketplace that is hosted by a server 14. The marketplace includes a server 14 that provides access to a creative content data store 16. The uploaded creative content 10 is stored on the creative content data store. One or more listeners may access and receive a downloaded creative content 16 and experience the downloaded creative content 16, such as by listening to it on a media player of a mobile computing device.

The creative content discovery marketplace also allows the artist to designate an incentive 12 for the one or more listeners to access and experience the artist's creative content 10. The creative content service retains and allocates the incentive 12 based on one or more parameters specified by the artist. When the one or more listeners download and experience the downloaded creative content 16, the individual listener receives a specified incentive 18 for their experiencing of the content based on the one or more artist specified parameters.

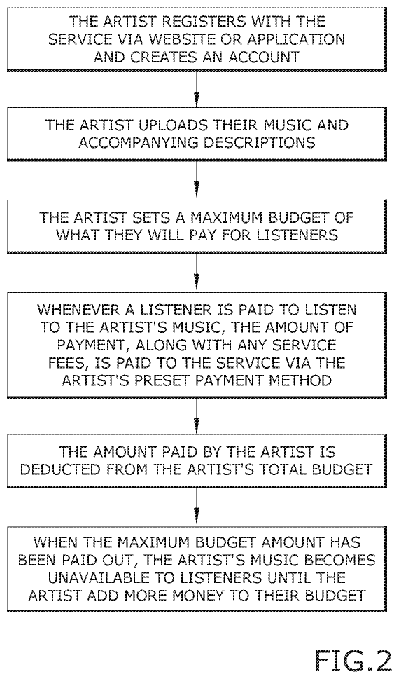

FIG. 2 illustrates a flowchart for an artist interaction with the creative content discovery marketplace. Upon accessing the creative content discovery marketplace, via a web browser or an app on a mobile computing device, the artist registers with the service to establish an account. Once the account is established, the artist may upload their creative content 10. The artist may provide a description and other identifying indicia to facilitate indexing and categorizing the creative content 10. The artist may then designate an incentive and specify one or more parameters for the listener to qualify for the incentive. The one or more parameters may be a total number of incentives, a temporal limit on the incentive, an incentive increment.

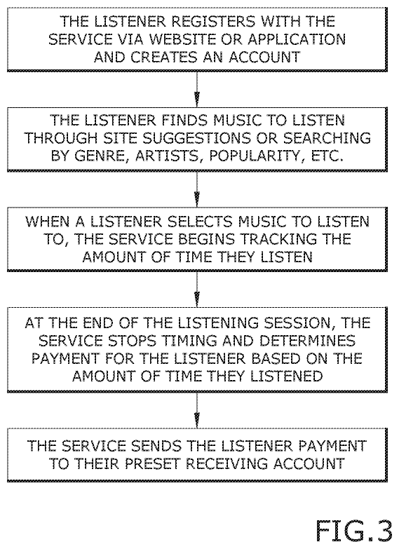

FIG. 3 illustrates a flowchart for a listener interaction with the creative content discovery marketplace. Upon accessing the creative content discovery marketplace, via a web browser or an app on a mobile computing device, the listener registers with the service to establish an account. Once the account is established, the listener may locate music to listen to through a variety methods. The content discovery marketplace may make suggestions or the listener may specify search criteria, such as genre, artist, popularity, and the like to find content they may desire. The creative content discovery marketplace also permits the listener to discover content by the incentive designated for the content by the artist. When the listener selects and downloads the content, the discovery marketplace begins tracking the length of time that the listener experiences the content. When the listener stops experiencing the content, the timing is terminated. The service then determines whether the listener has satisfied the specified parameters for receiving the incentive, and determines an incentive increment. If the listener has met the specified parameters, the service delivers the incentive increment to an account specified by the listener for receiving incentives.

In a non-limiting example of the invention, a musician uploads his music content onto his account through the website or app. The musician designates an incentive and incentive parameters for his listeners. For example the incentive may be a monetary amount of $100. The incentive parameter may specify that the incentive increment of $1 is available to the first 100 complete listens of the content. The incentive parameters may also specify a fractional amount of the incentive increment is available based on a partial listen.

The listeners log on to their accounts to locate and listen to the music. Once they locate the artist content, they download the content and begin listening. In this example, because artist has specified parameters for a partial listen, the listener gets a monetary incentive based on the amount of time spent listening to the music. By way of non-limiting example, for 2 minutes of a 4 minute song, the incentive increment would be 50 cents as opposed to a dollar.

By creating a site or application, or any platform digital or otherwise where the average listeners can be provided an incentive, a reward for listening to new music, listeners are encouraged to discover new creative content, rather than follow the crowd and purchase creative.

While the foregoing examples have described use in connection with a musical artist, the creative content discovery marketplace of the present invention may find applicability to a variety of creative works that may be digitally delivered. In another non-limiting example, a movie production company was to want to get new viewership for a lesser known movie, they could use the same method and pay the viewership per minute in order to build an audience.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of serving web pages providing a marketplace for discovering creative content of an artist, comprising:
receiving an upload of a creative content via a content submission page hosted by a server of a creative content discovery service provider;
receiving one or more artist specified identifying indicia for the creative content via the content submission page;
storing the creative content on a content data store;
receiving an incentive and one or more incentive parameters associated with the creative content via an incentive designation page hosted by server;
storing the incentive in an incentive account associated with the artist and the creative content;
providing a creative content search page accessible at the server, wherein the creative content is searchable by the identifying indicia and the incentive associated with the creative content.

2. The method of claim 1, further comprising:
delivering a listener selected creative content from the content data store to the listener.

3. The method of claim 2, further comprising:
automatically receiving, at the server, a playback start time of the selected creative content from the listener.

4. The method of claim 3, further comprising:
automatically receiving, at the server, a playback end time of the selected creative content from the listener and determining a playback duration.

5. The method of claim 4, further comprising:
automatically determining, at the server, whether the playback duration meets the one or more incentive parameters;
when the one or more incentive parameters are satisfied,
automatically determining, at the server, an incentive increment based on the playback duration and the one or more incentive parameters;
automatically delivering the incentive increment to a listener specified account; and
automatically decrementing the incentive increment from the incentive account.

6. The method of claim 5, further comprising:
determining whether a subsequent incentive increment based on a full play of the creative content is available in the incentive account; and
automatically blocking access to the creative content when a subsequent incentive increment based on a full play of the creative content is not available in the incentive account.

7. A non-transitory computer-readable memory adapted for use by a digital content discovery service provider in serving web pages offering a marketplace for discovering digital content of a creating artist, the non-transitory computer-readable memory used to direct a server of the content discovery service provider to perform the steps of:
receiving an upload of a creative content via a content submission page hosted by a server of a creative content discovery service provider;
receiving one or more artist specified identifying indicia for the creative content via the content submission page;
storing the creative content on a content data store;
receiving an incentive and one or more incentive parameters associated with the creative content via an incentive designation page hosted by server;
storing the incentive in an incentive account associated with the artist and the creative content;
providing a creative content search page accessible at the server, wherein the creative content is searchable by the identifying indicia and the incentive associated with the creative content.

8. The non-transitory computer-readable memory of claim 7, further comprising:
delivering a listener selected creative content from the content data store to the listener.

9. The non-transitory computer-readable memory of claim 8, further comprising:
automatically receiving, at the server, a playback start time of the selected creative content from the listener.

10. The non-transitory computer-readable memory of claim 9, further comprising:
automatically receiving, at the server, a playback end time of the selected creative content from the listener and determining a playback duration.

11. The non-transitory computer-readable memory of claim 10, further comprising:
automatically determining, at the server, whether the playback duration meets the one or more incentive parameters;
when the one or more incentive parameters are satisfied,
automatically determining, at the server, an incentive increment based on the playback duration and the one or more incentive parameters;
automatically delivering the incentive increment to a listener specified account; and
automatically decrementing the incentive increment from the incentive account.

12. The non-transitory computer-readable memory of claim 11, further comprising:
determining whether a subsequent incentive increment based on a full play of the creative content is available in the incentive account; and
automatically blocking access to the creative content when a subsequent incentive increment based on a full play of the creative content is not available in the incentive account.

13. A non-transitory computer-readable memory adapted for use by a mobile computing device to access a site a digital content discovery service provider serving web pages offering a marketplace for discovering digital content of a creating artist, the non-transitory computer-readable memory used to direct the mobile computing device to perform the steps of:
access a listener account hosted by the server;
receiving a creative content from a creative content data store of the service provider;
automatically sending a playback start time to the server upon initiating a playback of the creative content; and
automatically sending a playback stop time to the server upon terminating a playback of the creative content, wherein the playback start time and the playback stop time are used to determine a playback duration, and the playback duration is used to determine an incentive increment for the playback of the creative content.

14. The non-transitory computer readable memory of claim 13, further comprising:
providing a search interface, to search for the creative content based on an incentive specified by an artist associated with creative content.
